(19) United States
(12) Patent Application Publication
(10) Pub. No.: US 2009/0087372 A1
(43) Pub. Date: Apr. 2, 2009

(54) PROCESS FOR THE PREPARATION OF A CATALYST FOR THE PRODUCTION OF CARBON NANOTUBES

(75) Inventors: Sigurd BUCHHOLZ, Koln (DE); Volker Michele, Koln (DE); Leslaw Mleczko, Dormagen (DE); Rainer Bellinghausen, Odenthal (DE); Aurel Wolf, Wulfrath (DE)

Correspondence Address: NORRIS, MCLAUGHLIN & MARCUS, P.A., 875 THIRD AVE, 18TH FLOOR, NEW YORK, NY, 10022, US

(73) Assignee: Bayer MaterialScience AG, Leverkusen (DE)

(21) Appl. No.: 12/212,678

(22) Filed: Sep. 18, 2008

(30) Foreign Application Priority Data
Sep. 27, 2007 (DE) 10 2007 046 160.9

(51) Int. Cl. D01F 9/12; C01D 1/02; B01J 23/58

(52) U.S. Cl. 423/447.2; 423/594.6; 502/328; 423/447.1; 977/742

(57) ABSTRACT

A process for the preparation of a catalyst for the production of carbon nanotubes, the use of the catalyst for the production of carbon nanotubes, and the carbon nanotubes obtained by this production process. The catalyst is prepared on the basis of at least two metals from the group: cobalt, manganese, iron, nickel and molybdenum from soluble precursor compounds by spray drying or spray granulation of the precursor compounds dissolved in a solvent, and subsequent calcination.

The invention relates to a process for the preparation of a catalyst for the production of carbon nanotubes, to the use of the catalyst for the production of carbon nanotubes, and to the carbon nanotubes obtained by this production process. The catalyst is prepared on the basis of at least two metals from the group: cobalt, manganese, iron, nickel and molybdenum from soluble precursor compounds by atomization of the precursor compounds dissolved wholly or partially in a solvent, and subsequent calcination.

Carbon nanotubes are understood as being mainly cylindrical carbon tubes with a diameter of from 3 to 100 nm, the length is a multiple of the diameter, at least 20 times the diameter. Carbon nanotubes are referred to hereinbelow as “CNTs” for short. These tubes consist of layers of ordered carbon atoms and have a core that differs in terms of morphology. These carbon nanotubes are also referred to as “carbon fibrils” or “hollow carbon fibers”, for example. On account of their dimensions and their particular properties, the described carbon nanotubes are technically important for the production of composite materials. Other important possibilities are in electronics, energy and further applications.

Carbon nanotubes are a material that has been known for a relatively long time. Although Iijima is generally considered to have discovered nanotubes in 1991 (S. Iijima, Nature 354, 56-58, 1991), these materials, in particular fibrous graphite materials having a plurality of graphite layers, have been known for longer. For example, the deposition of very fine fibrous carbon from the catalytic decomposition of hydrocarbons was described as early as the 1970s and early 1980s (GB 1469930A1, 1977 and EP 56004 A2, 1982, Tates and Baker). However, the carbon filaments produced on the basis of short-chained hydrocarbons are not characterized in greater detail in respect of their diameter. The production of carbon nanotubes having diameters less than 100 nm is described inter alia also in EP 205 556 B1 or WO A 86/03455.

For the production there are here described light (i.e. short- and medium-chained aliphatic or mono- or bi-nuclear aromatic) hydrocarbons and an iron-based catalyst, on which carbon carriers are decomposed at temperatures above 800 to 900° C.

The known methods include, for example, arc discharge, laser ablation and catalytic processes. In the case of the catalytic processes, a distinction can be made between deposition on supported catalyst particles and deposition on metal centers formed in situ and having diameters in the nanometer range (so-called flow processes). In many of these processes, carbon black, amorphous carbon and fibers having large diameters (greater than 100 nm) are formed as by-products.

In the case of production by the catalytic deposition of carbon from hydrocarbons that are gaseous under reaction conditions (CCVD; catalytic carbon vapor deposition hereinbelow), acetylene, methane, ethane, ethylene, butane, butene, butadiene, benzene and further carbon-containing starting materials are mentioned as possible carbon donors. The catalysts generally contain metals, metal oxides or decomposable or reducible metal components. For example, Fe, Mo, Ni, V, Mn, Sn, Co, Cu and others are mentioned as metals in the prior art. Although most of the individual metals have a tendency to form nanotubes, high yields and low amorphous carbon contents are advantageously achieved according to the prior art with metal catalysts that contain a combination of the above-mentioned metals. The formation of carbon nanotubes and the properties of the tubes that are formed are dependent in a complex manner on the metal component, or a combination of a plurality of metal components, used as catalyst, the support material used and the interaction between the catalyst and the support, the starting material gas and partial pressure, the admixture of hydrogen or further gases, the reaction temperature and the residence time or the reactor used.

Various processes and catalysts are known for the production of carbon nanotubes. EP 0205 556 A 1 (Hyperion Catalysis International) describes such carbon nanotubes. The cited patent application describes an iron-containing catalyst and the reaction of a wide variety of hydrocarbons at high temperatures above 800 to 1000° C. The use of Ni as catalyst is also described, for example dissertation M. G. Nijkamp, Utrecht University, NL, 2002 “Hydrogen Storage using Physisorption Modified Carbon Nanofibers and Related Materials”. Likewise, Shaikhutdinov et al. (Shamil' K. Shaikhutdinov, L. B. Avdeeva, O. V. Goncharova, D. I. Kochubey, B. N. Novgorodov, L. M. Plyasova, “Coprecipitated Ni—Al and Ni—Cu—Al catalysts for methane decomposition and carbon deposition I.”, Applied Catalysis A: General, 126, 1995, pages 125-139) describe Ni-based systems as being active in the decomposition of methane to carbon nanomaterials. A further overview of production methods is given, for example, by Geus and DeJong in an overview article (K. P. DeJong and J. W. Geus in Catal. Rev.-Sci. Eng., 42(4), 2000, pages 481-510).

For the production of a particular modification of carbon nanotubes especially for use in polymers, the use of supports having a well-defined structure is also reported, for example in U.S. Pat. No. 6,358,878 B1 (Hyperion Catalysis International Inc.). A partially parallel orientation of the long nanotubes and fibers into bundles is achieved by the use of support materials which have a structure of cleavable planar surfaces or consist of crystallites having such cleavable surfaces. Although these materials yield a material that is particularly suitable for use in polymers, the active components are preferably applied by soaking and impregnation processes. However, as is generally known in the literature relating to the preparation of heterogeneous catalysts, the amount of catalyst loading is limited if the degree of dispersion is at the same time high. Very high degrees of dispersion, or small diameters of the active catalyst components, are advantageous for the growth of carbon nanotubes, however. Small active component diameters are achieved in the case of impregnation or precipitation on catalyst supports only if the loading is low and the degree of dispersion is high. The performance of the catalysts used is thereby limited considerably. In U.S. Pat. No. 6,358,878 B1, typical yields of the order of magnitude of from 20 to 25 times the amount of catalyst used are mentioned. Higher yields are not disclosed. The content of catalyst and support residues in the described catalysts is so high that these residues must be removed for further use. This leads to an increased technical effort, which results in a plurality of further process steps. Furthermore, the morphology and properties of the carbon nanotubes may be influenced by the working-up and purification, depending on the chosen procedure.

The simple removal of the catalyst residues from the CNTs is, for example, also the aim of application WO 03/004410 A1. The use of soluble supports such as hydroxides and/or carbonates of Ca, Mg, Al, Ce, Ti, La as supports is mentioned as a solution to this problem. The preparation thereof by intensive mixing of the catalytically active components with the alkaline support components is carried out virtually in the dry state (optionally in the pasty state) in mixing apparatuses such as, for example, ball mills, kneaders, etc. The micromixing of the powders so prepared is suboptimal and leads to considerable variations in the diameter of the metal clusters and accordingly of the CNTs.

In principle, the catalysts described in the prior art have the disadvantage that the effort for the preparation of the heterogeneous catalyst is comparatively high. In the preparation of supported catalysts, it must be ensured that the primary crystallites that contribute to growth are sufficiently dispersed. This can be achieved, for example, as is known in heterogeneous catalysis, by impregnation with comparatively low contents of active metals [Handbook of Heterogeneous Catalysis, Vol. 1, 1997, Chap. 2.2.]. Owing to the comparatively low surface concentration of catalytically active metal, adequate dispersion and hence the small diameter of the active metal clusters are ensured. In the case of precipitation of the active components on supports of a specific particle size which have been introduced beforehand or on a suspension of particulate catalyst supports (typically aluminium, magnesium, silicon, zirconium oxides and others), a change in the conditions is generally required, which can be, for example, jumps in temperature, jumps in concentration and the addition of a precipitation agent [Handbook of Heterogeneous Catalysis, Vol. 1, 1997, Chap. 2.1.3.]. An additional component is hereby introduced into the system and additional waste and by-product streams are formed, in particular when a precipitation agent is used. In addition, the secondary components resulting from the precipitation, such as alkali oxides and halides, can result in the impairment of the catalytic properties. As a result, time-consuming washing of the resulting catalyst solid is necessary in many cases. For example, WO 2006/050903 A2 discloses a process for the preparation of a catalyst for the production of CNTs in which the precursor compounds for the catalyst are subjected to an alkaline precipitation reaction and the catalyst is further prepared in a complex manner from the precipitated mixed hydroxides. On account of the many local parameters in the precipitations and impregnations it is further known that a scale-up of the preparation is associated with major difficulties, so that catalysts having a broad distribution of the metal cluster diameters is usually obtained in practice.

In particular in the case of the production of carbon nanotubes, a narrow particle diameter distribution is important in order reproducibly to obtain the diameters of the carbon nanomaterials that are desired in the product. WO 2007/093337 A2 describes the preparation of a catalyst by means of continuous precipitation in a micromixer. Although very small metal cluster diameters, or at the same time a very narrow distribution of the diameters, are achieved thereby, the process requires expensive filtration and washing steps in order to prepare a highly active catalyst.

A further disadvantage in the preparation of the catalysts according to the preceding prior art is that a loss of active components by wet-chemical preparation in the form of precipitation or soaking must be accepted. In most cases, the solutions can be recycled only with difficulty because of the high dilutions in which the catalytically active metals are obtained.

A further complex problem is shaping of the resulting catalysts. If they are to be used in a process in which the catalyst particles or catalyst/carbon nanomaterial agglomerates or carbon agglomerates are moved inside the reactor by the flow of a fluid or in which the solid material contained in the reactor is moved, a defined particle size distribution is necessary, which often permits efficient reactor operation that is not susceptible to breakdown only within narrow limits. Particle size here refers to the size of a loaded support or the mixture of support and active metals used in the reaction. In the case of a conventional catalyst, therefore, additional process steps, such as, for example, comminution or agglomeration and screening, are necessary. In the latter case, the yield of catalyst from precipitation reactions can be markedly reduced. There is further the risk that impurities, for example from apparatuses or other batches, may influence the quality of the material.

CNT catalysts having a defined particle size are required in particular when the catalysts are used for reaction in a fluidized bed, a circulating fluidized bed, a moving bed, likewise for other reasons in a fixed bed (in order to reduce the pressure loss over the bulk catalyst), in a floating reactor, entrained bed reactor, a pneumatic transport reactor, downer or riser. In the mentioned reactors, the particle velocity, and hence generally the mixing time or residence time in the reactor, is dependent on the particle diameter, and as narrow a particle size distribution as possible is therefore technically advantageous.

The object of the present invention is to develop a process for the preparation of catalysts for CNT production, which process avoids the mentioned disadvantages of the known processes and in particular operates in an energy-efficient manner, makes efficient use of the materials employed in the catalyst preparation, preferably minimizes the amount of waste that is formed in the catalyst preparation or the waste water that is to be recycled and accordingly minimizes the number of working steps in the preparation of the catalyst in solid form and, in particular, allows an advantageous particle size of the catalyst to be adjusted.

In particular, it is to be possible to recycle such catalyst material that is not obtained, for example, in the range of the desired particle size distribution into the preparation process. It is also preferably to be possible to use the resulting catalyst in all the reactor types mentioned above, in particular in moving beds such as fluidized beds.

Surprisingly, tests have shown that suitable catalysts can be prepared in an unexpectedly simple manner from salt solutions of the active metals and support materials in predominantly or wholly dissolved form by spray drying or spray agglomeration.

The present invention relates to a process for the preparation of a catalyst based on at least two catalytically active metals from the group: cobalt, manganese, iron, nickel and molybdenum for the production of carbon nanotubes, comprising the steps:
a) dissolution of at least two thermally decomposable precursor compounds of the catalyst selected from the group of the salts of: cobalt, manganese, iron, nickel and molybdenum in a solvent to form a solution optionally containing suspended, undissolved precursor compounds, preferably in an aqueous solvent,
b) removal of the solvent by spray granulation or spray drying with a drying gas having a temperature of from 150 to 600° C., preferably by means of nozzle or disc atomizers, in particular to obtain an outlet temperature of the waste gas (=mixture of drying gas and solvent vapor) of at least 70° C., preferably from 70 to 200° C., particularly preferably from 80 to 120° C., to obtain intermediate granular material,
c) optional grinding of the intermediate granular material obtained in step b) and optional further drying of the intermediate granular material obtained in step b) at a temperature of from 60 to 500° C.,
d) optional screening of the intermediate granular material obtained in step b) or c) to give granules having a particle diameter in the range from 30 to 100 μm, preferably from 40 to 70 μm,
e) optional further drying of the granules obtained in step d) at a temperature of from 60 to 500° C.,
f) calcination of the intermediate granular material obtained in step b) or c) or the granules obtained in step e) in the presence of an oxygen-containing gas, in particular in the presence of air, at a temperature of from 200 to 900° C., preferably from 250 to 800° C., particularly preferably from 300 to 700° C., with a treatment time of at least 0.5 hour, preferably from 1 to 24 hours, particularly preferably from 2 to 16 hours, with removal of the decomposition gases to give the catalyst,
g) optional subsequent reduction of the catalyst from step f) by means of reducing gases, in particular using hydrogen, in particular at a temperature of from 250 to 750° C.

The novel process is described again generally hereinbelow.

In a first step, the catalytically active materials and the support substances are dissolved in a solvent and any fractions that are no longer dissolved are suspended. Suitable solvents therefor are, for example, water, alcohols, low-boiling aliphatic and aromatic hydrocarbons, carbon-containing solvents in general, for example nitromethane or supercritical CO₂. Owing to the ready usability of known techniques, alcoholic or aqueous solvents or mixtures thereof are preferred. Aqueous solvents are particularly preferred.

Suitable precursor compounds for the catalytically active materials and the support substances are preferably those compounds which can be dissolved in the solvent or solvent mixture that is used and which can be decomposed thermally to give the corresponding catalyst compound (i.e. metal oxides) after the solvent has been removed. Examples of suitable compounds are inorganic salts, for example: the hydroxides, carbonates, nitrates and the like as well as oxalates or salts of lower carboxylic acids, in particular acetates or derivatives, as well as organometallic compounds, for example acetylacetonates, of the metals cobalt, manganese, iron, molybdenum and nickel, it being possible for the metals to be in any possible oxidation state. One or more support components can optionally also be added to the solution in the form of an insoluble solid, so that suspensions are obtained. The particle size of the solid is advantageously preferably smaller than the particle diameter of the catalyst agglomerates obtained by the process as a whole. In a further preferred variant of the first process step, fine dust from the screening in step d) (i.e. particles whose diameter is below a given specified range) is added to the solution/suspension, the fine dust particles acting as seed crystals and the overall yield of the process being increased by the recycling of the fine dust.

The maximum temperature of the gas mixture of drying gas and solvent that emerges from the drier used for treatment in the spray granulation or spray drying is so chosen that tacky phases of the solid formed in the spray granulation or spray drying do not form in the outlet from the drier.

The chosen gas inlet temperature of the drying gas for the drying is to be as high as possible in order to achieve as high a drying efficiency as possible. The gas inlet temperature can be chosen in the range from 150 to 600° C. If no safety-related concerns or quality losses are to be feared from thermal decomposition of dry material that has been blown back or from caking in the gas inlet region, the preferred drying gas inlet temperature is in the range from 300 to 500° C. Air or inert gas, in particular nitrogen, is used as the drying gas.

In the spray drying [see: K. Masters, “Spray Drying Handbook”, Longman Scientific & Technical 1991, 725 pages, ISBN 0-582-06266-7], liquid slurry, for example a solution or suspension, is divided into more or less small drops and dried by contact with a hot gas stream. There is obtained a powder whose particle size distribution can be decisively adjusted by the drop size distribution. Because spray drying is brief drying with a residence time of from just under 1 second to a maximum of about 30 seconds, depending on the length of the tower, the drops are generally to be adjusted to below 500 μm, in laboratory apparatuses with correspondingly short residence times to <50 μm. Because it is possible to produce coarse dry material, as is known from granulation technologies, at least in longer spray towers with particle diameters above 100 to 200 μm, the term spray granulation is frequently also used. In addition, however, downstream agglomeration processes, which can also be integrated into the cone region of the spray tower, are also possible [see Gehrmann et al., “Trockner”, Chem. Ing. Tech. (75) 2003, 1706-1714].

The atomization of the slurry can be carried out using so-called two-component nozzles, which are preferably used with a low throughput and in order to obtain small drops. Atomizing gas, mostly compressed air or nitrogen, is thereby applied. Depending on the supply, a distinction is made between two-component nozzles with external or internal admixture. The former is generally operated with larger gas amounts up to gas throughputs of 2 kg of gas per kg of slurry, in order to achieve drop sizes below 50 μm. In the case of two-component nozzles with internal mixing, smaller gas throughputs of about 0.1 kg of gas per kg of slurry are generally sufficient. Alternatively, for the application provided here with relatively small particle sizes below 100 μm, it is also possible to use disc atomizers, which are operated with a speed in the region of 20,000 rpm and with circumferential speeds of 100 m/s and more. Both technologies, two-component nozzle and disc, are suitable especially for smaller drop diameters <100 μm. Although coarser drops can also be produced by appropriately reducing the amount of gas or the speed, a fines content is unavoidable. Narrower drop distributions can generally be achieved by single-component nozzles in which the atomizing energy is provided by increased admission pressure of the slurry. At a pressure of approximately from 5 to 20 bar, coarser drops having a diameter d₅₀>100 μm can be adjusted. At a higher pressure of from 50 to 100 bar, in exceptional cases up to 300 bar, finer drop diameters can be adjusted, however, depending on the viscosity and surface tension of the slurry. The single-component nozzle is suitable especially for high throughputs because relatively expensive compressed gas is not used, but it is sensitive towards throughput variations. The single-component nozzle appears to be advantageous for large-scale use. On the development scale, on the other hand, two-component nozzles have been more successful.

The residual moisture of the spray-dried product can be adjusted within specific limits, dependent on the product-specific drying behavior, by the waste gas temperature of the drier. The chosen gas inlet temperature, on the other hand, is as high as possible, because the temperature difference in the drier also determines the throughput. During drying, owing to evaporative cooling, the product assumes a steady-state temperature that is markedly lower compared with the gas temperature, generally from 40 to 100° C., depending on the solvent load in the drying gas. The dry material then very quickly assumes the local gas temperature, so that the product leaves the drier with approximately the waste gas temperature. If there is no risk of over-drying and also no risk of adhesion of the dry material owing to higher temperatures and the melt processes associated therewith, a higher waste gas temperature can be tolerated in order at the same time to temper the product. However, a corresponding reduction in the throughput must be accepted in return. In general, therefore, any tempering that is required is carried out downstream in suitable apparatuses. It is possible to use the waste heat from the tempering for the drying, and the overall energy consumption can be reduced as a result.

The solid material obtained in step b) has no or only a small amount of residual moisture, depending on the procedure, and is screened in step d) as described. Undesirable coarse material or fine material can be extracted in the screening and fed into the processes according to step a) or b) again. Shaping treatment is additionally possible by way of exception, for example by compression, tablet formation or agglomeration of the intermediate product, if the form desired in the subsequent CNT production process has not yet been achieved. This is usually unnecessary, however. It is possible to insert further process-related steps, for example dust removal, compaction or, in particular, drying and grinding of the intermediate product, prior to the screening. Grinding and drying (optional step c)) can usually be dispensed with because the intermediate product is in most cases obtained in the desired particle size from the spray-drying process according to step b). Preference is given to screening and re-use of the fraction of the intermediate product that has a size outside the desired particle size range, without additional solids treatment or shaping. In the case of the fine dust (i.e. the fraction of the particles whose diameter is below the specified limit) such re-use is possible and preferable without further treatment by returning the dust to the preparation of the solution (step a)); for the coarse material (i.e. particles whose diameter is above the specified limit), a comminution step prior to re-use is generally unavoidable.

The resulting, optionally screened, catalytically active intermediate product from step c) or b) is then optionally further dried (step e)) and then calcined (step f)). To this end, batchwise or continuous methods can be used. Depending on the starting materials used, decomposition products (e.g. NOₓ) are formed, which must be separated in the process. Processes therefor are known to the person skilled in the art from the technical preparation of catalysts. Further drying according to step e) preferably takes place at a temperature of from 150 to 300° C. in the case of temperature-stable catalyst intermediate products which do not form tacky phases by melting processes, and preferably takes place in the range from 80 to 120° C. in the case of temperature-sensitive catalyst intermediate products which have a tendency to form tacky phases.

Depending on the starting materials used, the calcination temperature can be raised or lowered continuously or stepwise.

Depending on the required calcination temperature, the step of drying and calcination can be combined in step b), and spray-pyrolyzed material can be obtained directly. It can further be necessary, owing to the degree of moisture and degree of reaction of the precursors to be decomposed, to insert a further calcination stage downstream of a spray pyrolysis part, the waste heat of which further calcination stage can be used in the spray drying.

The described thermal treatment (calcination according to step f)) can be carried out, for example, in fixed beds, rack ovens, fluidized and agitated beds, drum-type furnaces, risers, downers, circulating systems. The calcination time is also dependent on the choice of reaction apparatus and is adapted accordingly.

Depending on the catalytically active metals used, a reduction may optionally be advantageous. This can be carried out in the reactors described above for step e), separately or in situ, by addition of a fluid containing a reducing agent, in particular hydrogen.

Preferred particular embodiments of the invention are described hereinbelow:

The solvent for step a) is preferably selected from at least one solvent from the group: water, alcohols, low-boiling aliphatic and aromatic hydrocarbons, nitromethane or supercritical CO₂, preferably water and alcohols, or possible mixtures thereof.

In a preferred process, the further drying e) is carried out, for a product that tends to form tacky phases, at a temperature of from 80 to 120° C., in order to prevent melting. In the preceding spray drying it is necessary, in the case of such products, to operate at low waste gas temperatures and high residual moisture contents, in order to avoid melt processes and the corresponding formation of tacky phases, so that further drying is generally unavoidable.

In a further preferred alternative process, the drying e) is carried out at a temperature of from 150 to 300° C., in order to remove bound water in the form of hydrate shells before the calcination. This is possible if the material does not have a tendency to adhesion as described above.

The screening d) is particularly preferably carried out in such a manner that granules having a particle size in the range from 40 to 70 μm are obtained. The mean catalyst particle diameter is chosen according to the desired size of the CNT agglomerates to be produced. As narrow a particle size distribution as possible is technically advantageous in particular for the use of the catalyst in a fluidized bed, because there is usually only a relatively narrow velocity window in which the heavier large CNT agglomerates do not defluidize in the reactor and at the same time the fine catalyst particles are not discharged from the bed at the top, that is to say in which steady-state operation of the reactor is possible without particular recycling measures.

In a preferred process, the precursor compounds are selected from hydroxides, carbonates, nitrates, oxalates or other salts of lower carboxylic acids, in particular acetates, of the metals Co, Mn, Fe, Ni and Mo. The precursor compounds particularly preferably include hydroxides, carbonates or nitrates, in particular nitrates, at least of cobalt and manganese.

In a particularly preferred variant of the novel process, together with the precursor compounds for the catalyst, precursor compounds for a catalyst support selected from the group of the metal compounds of: alkaline earth metals (e.g. magnesium, calcium), aluminium, silicon, titanium, cerium and lanthanum, preferably hydroxides, carbonates or nitrates of alkaline earth metals, aluminium, silicon, titanium and titanium, are dissolved and/or suspended in the solvent in step a).

A preferred process in which the further drying e) and the calcination f) are carried out in a common reaction chamber is particularly efficient in terms of energy.

The spray granulation or spray drying according to step b) is preferably carried out using a single-component atomizing nozzle or a two-component atomizing nozzle, with admixture of inert gas or air during the atomization. In the case of single-component atomization, the required energy for producing the drops (surface energy) is acquired only from the liquid, which to that end is conveyed through a small nozzle opening with a high admission pressure and a correspondingly high velocity. The mean diameter and the width of the diameter distribution of the resulting drops can be adjusted in the desired manner by the appropriate choice of the admission pressure and nozzle diameter and in dependence on the material properties of further parameters, such as, for example, the geometry of the upstream spin or mixing chamber. In the case of two-component atomization, the required energy for producing the drops is acquired not, or not exclusively, from the liquid but additionally, under high pressure, a gas is brought into contact with the jet of liquid. The liquid admission pressure can be considerably lower than in the case of single-component atomization or can be omitted altogether. The choice of the suitable process for a given atomization object is additionally dependent on the desired throughputs. The precise operating parameters can generally be established after carrying out corresponding preliminary tests, because the mutual dependencies of the parameters are complex.

In the case where the spray granulation or spray drying is carried out using a single-component atomizing nozzle, the pressure difference over the nozzle is from 5*10⁵ to 300*10⁵ Pa (from 5 to 300 bar), preferably from 20*10⁵ to 100*10⁵ Pa (from 20 to 100 bar), particularly preferably from 40*10⁵ to 70*10⁵ Pa (from 40 to 70 bar).

In the case where the spray granulation or spray drying b) is preferably carried out using a two-component atomizing nozzle, this step is carried out with the admixture of inert gas or air, the ratio of the gas mass flow to the liquid mass flow being from 0.1 to 1 to 2 to 1. The smaller air amounts can be achieved predominantly in two-component nozzles with internal mixing and liquid admission pressure and involve the risk of nozzle blockage in addition to the saving of compressed gas. In two-component nozzles with external mixing, there is less of a risk of the nozzle becoming blocked, but more atomizing gas must generally be used.

A further alternative preferred process is characterized in that there is used for removing the solvent in step b) a disc atomizer which is operated with a speed of the atomizer disc in the range from 2000 to 20,000 rpm, in particular, depending on the diameter of the disc, with a circumferential speed of from 50 to 150 m/s. The advantage of disc atomization is the saving in terms of compressed gas and liquid admission pressure, as well as broad local distribution of the drop spray in the spray tower with only one atomizing member.

Also very advantageous is a preferred variant of the novel process in which the waste gases and/or hot gases obtained in the further drying e) and/or calcination f) are fed back for heat exchange when the spray drying is carried out.

The invention also provides a catalyst for the production of carbon nanotubes, which catalyst is obtained from the process according to the invention.

The catalyst material obtained by the catalyst preparation process according to the invention can in principle be used in the described reactor types for the production of nanostructured carbon materials which are also nanoscale at least in one spatial direction, in particular carbon nanotubes, by decomposition of carbon-containing gases or mixtures thereof at elevated temperature in the presence or absence of inert gases, that is to say gases which are not directly involved chemically in the decomposition reaction. Because the catalyst preparation process according to the invention makes active catalytic materials available for a broad range of applications, a broad range of reaction parameters, for example reaction temperature (T=300° C.-2500° C.), concentrations (one or more carbon-containing starting material gases which form nanoscale carbon materials under the chosen conditions) and residence time (residence time of the catalytically active material, of the mixtures of catalytically active material and nanoscale carbon materials and of the carbon nanomaterials consisting mainly of carbon) in the range from 0.01 s<t<36,000 s (10 h) can be applied.

An admixed inert gas, hydrogen or the carbon-containing starting material gas can be recycled in the process. The carbon-containing starting material gas can contain compounds having any desired heteroatoms, such as, for example, nitrogen, and sulfur. It is possible to add separately to the process specific substances which, in the deposition, produce an incorporation of heteroatoms into the carbon structure of the nanomaterials.

The invention further provides the process for the production of fibrous carbon materials, in particular carbon nanotubes having a mean individual diameter of from 2 to 60 nm and an aspect ratio length:diameter (L:D)>10, by decomposition of hydrocarbons with and without heteroatoms, in particular C₁— to C₅-alkanes or C₂— to C₅-alkenes, on a catalyst in the presence of inert gas and optionally hydrogen at a temperature of from 450 to 1200° C. in a fixed bed or a moving bed, preferably a fluidized bed, and working up and purification of the resulting carbon nanotubes, characterized in that a catalyst obtained from the catalyst preparation process according to the invention is used.

The invention also provides the use of the catalyst obtained from the catalyst preparation process according to the invention in the production of carbon nanotubes or agglomerates of carbon nanotubes.

The separation of the nanoscale carbon materials from the catalyst used and the optional purification take place by physical and/or chemical methods which are known in principle from the prior art. In a preferred embodiment of the invention, the catalytically active metals and support materials obtained in the purification are returned to the preparation process.

The carbon nanotubes obtained by the process according to the invention consist substantially of largely concentric graphite layers with low-defect tube sections or have a herringbone or helix structure and have an unfilled or filled core.

The carbon nanotubes are particularly preferably obtained in the form of agglomerates, the agglomerates having in particular a mean diameter in the range from 0.5 to 2 mm. A further preferred process is characterized in that the carbon nanotubes have a mean diameter of from 3 to 100 nm, preferably from 3 to 80 nm, particularly preferably from 5 to 25 nm.

The carbon nanomaterials obtainable by the CNT production process according to the invention are suitable for use as an additive in polymers, in particular for mechanical strengthening and for increasing the electrical conductivity. The described carbon nanomaterials can also be used as a material for gas and energy storage, for coloring and as a flame retardant. Because of their good electrical conductivity, the carbon nanomaterials produced according to the invention can be used as an electrode material or for the production of strip conductors and conductive structures. It is also possible to use the carbon nanotubes according to the invention as emitters in displays. The carbon nanomaterials are preferably used in polymer composite materials, ceramics or metal composite materials for improving the electrical or heat conductivity and mechanical properties, for the production of conductive coatings and composite materials, as a coloring, in batteries, capacitors, displays (e.g. flat screen displays) or illuminants, as a field effect transistor, as a storage medium, e.g. for hydrogen or lithium, in membranes, e.g. for the purification of gases, as a catalyst or as a support material, e.g. for catalytically active components in chemical reactions, in fuel cells, in the medical field, e.g. as a structure for controlling the growth of cell tissue, in the diagnostic field, e.g. as a marker, and in chemical and physical analysis (e.g. in atomic force microscopes).

### BRIEF DESCRIPTION OF THE DRAWINGS

The invention is explained in greater detail hereinbelow, by way of example, with reference to embodiments and figures, in which

FIG. 1 shows a transmission electron microscope photograph of carbon nanomaterial which has been produced using catalyst according to Example 2 prepared according to the invention (TEM: FEI/Philips Tecnai 20 LaB₆ cathode, camera Tietz F114T 1x1K, method according to manufacturer's instructions),

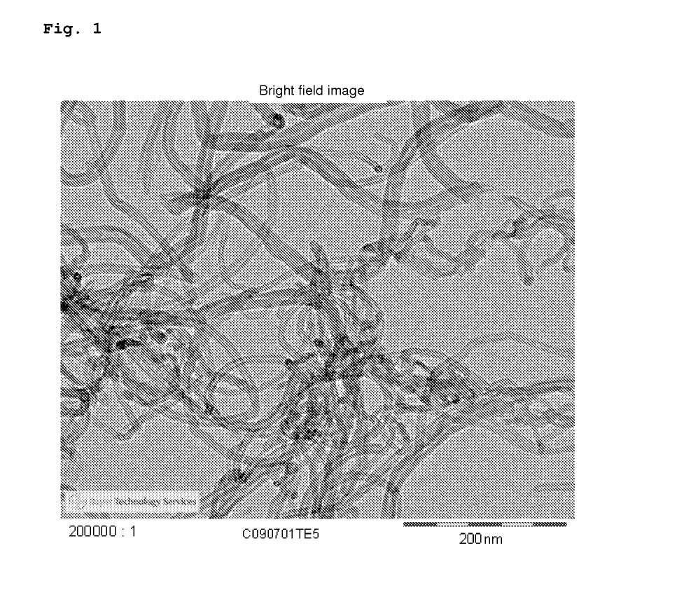

FIG. 2 shows a high-resolution transmission electron microscope photograph of carbon nanomaterial produced using catalyst according to Example 2 prepared according to the invention (TEM: FEI/Philips Tecnai 20 LaB₆ cathode, camera Tietz F114T 1x1K, method according to manufacturer's instructions),

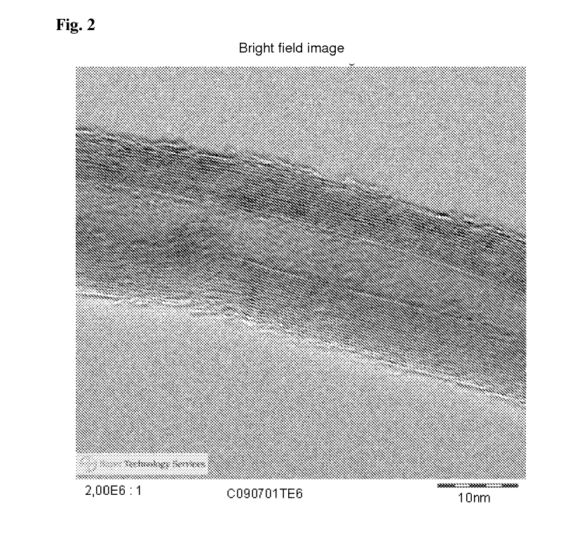

FIG. 3 shows a scanning electron microscope photograph of carbon nanomaterial which has been produced using catalyst according to Example 3 prepared according to the invention (REM: FEI SFEGSEM Sirion 100 T, method according to manufacturer's instructions).

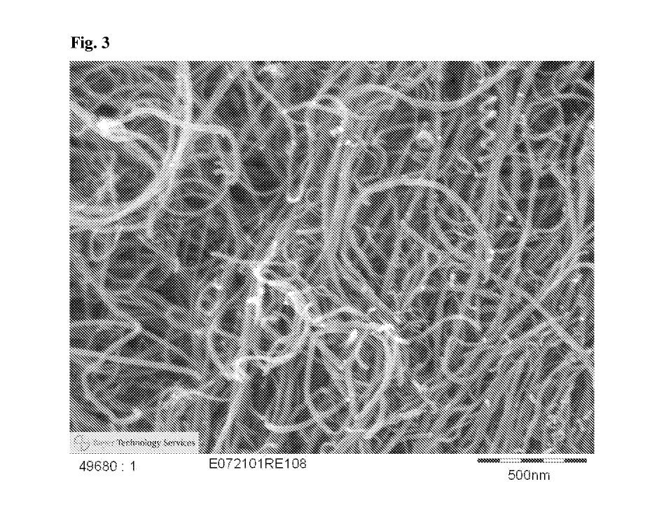

### EXAMPLES

### Example 1

### Preparation of a Catalyst by Spray Drying and Subsequent Calcination

Four solutions were prepared of 213.2 g of Co(NO₃)₂*6H₂O in 549.5 ml of deionised water, 186.8 g of Mn(NO₃)₂*4H₂O in 549.5 ml of deionised water, 395.6 g of Al(NO₃)₃*9H₂O in 384.6 ml of deionised water and 336.3 g of Mg(NO₃)₂*6H₂O in 384.6 ml of deionised water. The Mn— and Co-containing solutions and the Al— and Mg-containing solutions were combined and stirred for 5 minutes at room temperature. The resulting two solutions were then likewise combined and stirred for 5 minutes. Any cloudiness was dissolved by the dropwise addition of dilute HNO₃. 2.84 kg of this solution were metered for one hour in a Nubilosa spray drier (d=0.8 m, H_{cylinder}=1 m, Nubilosa two-component nozzle, product deposition via cyclone). The inlet temperature was 180° C., while the outlet temperature (after the cyclone) was 92° C. N₂ was thereby metered with a volume flow of 100 Nm³/h. About 282 g of solid were removed from the cyclone. The solid had a primary particle size (diameter) in the range from 5 to 50 μm; the product tended to agglomerate in the discharge from the drier, which results in coarsening of the grain size. The solid was then dried further overnight at 180° C. and subsequently calcined in air for 4 hours at 400° C. The yield after the calcination was 55%. The theoretical ratio of the active metals used, based on the support material, is Mn:Co:Al₂O₃:MgO=17:18:44:22.

### Example 2

### Use of the Catalyst Described in Example 1 in the Synthesis of Carbon-Containing Nanomaterials in a Fixed Bed Reactor

The catalysts were tested in a fixed bed apparatus on a laboratory scale. To this end, a given amount of catalyst from Example 1 was placed in a quartz tube having an inside diameter of 9 mm, which was heated from the outside by a heat transfer medium. The temperature of the bulk solids was regulated by PID control of the electrically heated heat transfer medium. The temperature of the bulk catalyst or of the catalyst/nanotubes mixture was determined by a thermal element surrounded by an inert quartz capillary. Starting material gases and inert diluent gases were passed into the reactor via electronically controlled mass flow regulators. The catalyst samples were first heated to the reaction temperature of 650° C. in a stream of hydrogen and inert gas. When the reaction temperature was reached, the starting material gas ethene was switched on. The volume ratio of the starting material gas was ethene:hydrogen:Ar=45:60:5. The total volume stream was adjusted to 110 mLN·min⁻¹. The catalyst was exposed to the starting material gases for a period of from 100 to 120 minutes, generally until the catalyst was completely deactivated. The amount of deposited carbon was then determined by weighing. The structure and morphology of the deposited carbon were determined by means of REM and/or TEM analyses. The amount of deposited carbon, based on catalyst used, referred to hereinbelow as the yield, was defined on the basis of the mass of catalyst after calcination (mCat,0) and the increase in weight after reaction (mTotal−mCat,0): yield=(mTotal−mCat,0)/mCat,0. The yield of the catalyst prepared in Example 1 was 25.385 g of CNTs/g of catalyst.

### Example 3

### Use of the Catalyst Described in Example 1 in the Synthesis of Carbon-Containing Nanomaterials in a Fluidized Bed

The catalysts were tested batchwise in a bench-scale fluidized bed apparatus. The apparatus consists of a stainless steel reactor having a diameter of ID=100 mm and a height of about 1200 mm, equipped with a widened head. The product was discharged in the lower third at a marked distance from the gas distributor. In the upper part, beneath the reactor head, the catalyst can be added via a transfer tube system. The supply of catalyst and the discharge of product or product and catalyst can be carried out batchwise or semi-continuously. The reactor is heated electrically and provided with commercial mass flow regulators for the supply of starting material gas. The bed temperature of the bulk filling in the reactor can be measured and regulated by means of a plurality of thermal elements.

In the test, a grain fraction of from 32 to 80 μm was prepared by screening from the material prepared in Example 1. The temperature inside the reactor was adjusted to T=650° C. (heating in N₂) and was regulated during the test. In 2 successive tests, 20 g of catalyst and 25 g of catalyst were added. The catalyst was mixed with a small amount of carbon nanotubes in order to facilitate metering on a laboratory scale. After each addition, a starting material stream of 4 LN/minute of nitrogen and 36 LN/minute of ethylene was adjusted and the reaction was continued until the onset of a drop in the conversion was observed. The initial conversions were between X_{C2H4}=67% and X_{C2H4}=72%. After the reaction time of each test, the reaction chamber was rendered inert and the material was removed and fresh catalyst was fed in. From a total of 45 g of added catalyst, 1514 g of carbon nanotubes were thus produced, which corresponds to a yield of 33.64 g of carbon nanotubes per g of catalyst added to the reactor. The error in the carbon balance was less than 4%. Small amounts (selectivity less than 8% in each case) of ethane and methane were detected as gaseous by-products by means of gas chromatography.

The catalyst prepared by the spray process according to the invention is distinguished from the prior art by its simple, time- and cost-saving preparation and the high activity of the catalyst according to the invention, and also by the high quality of the carbon nanotubes produced therewith.

What is claimed is:

1. A process for producing a catalyst based on at least two metals selected from the group consisting of: cobalt, manganese, iron, nickel and molybdenum, said process comprising the following steps:
a) dissolving at least two thermally decomposable precursor compounds of the catalyst in a solvent to form a solution optionally containing suspended, undissolved precursor compounds, wherein said precursor compounds of the catalyst are selected from the group consisting of salts of at least one of cobalt, manganese, iron, nickel and molybdenum,
b) removing the solvent by spray granulation or spray drying with a drying gas having a temperature of from 150 to 600° C. to obtain intermediate granular material,
c) optional grinding of the intermediate granular material obtained in step b) and optional further drying of the intermediate granular material obtained in step b) at a temperature of from 60 to 500° C.,
d) optional screening of the intermediate granular material obtained in step b) or c) to give granules having a particle diameter in the range from 30 to 100 μm,
e) optional further drying of the granules obtained in step d) at a temperature of from 60 to 500° C.,
f) calcination of the intermediate granular material obtained in step b) or c) or the granules obtained in step e) in the presence of an oxygen-containing gas at a temperature of from 200 to 900° C. with removal of decomposition gases to give the catalyst, and
g) optionally subsequently reducing the catalyst by subjecting the catalyst to reducing gases.

2. Process according to claim 1, wherein the solvent for step a) is at least one solvent selected from the group consisting of: water, alcohols, low-boiling aliphatic and aromatic hydrocarbons, nitromethane and supercritical CO₂ and mixtures thereof.

3. Process according to claim 1, which comprises drying step e), wherein the drying e) is carried out at a temperature of from 80 to 120° C. for a product that tends to form tacky phases and at a temperature of from 150 to 300° C. for a product that does not tend to form tacky phases.

4. Process according to claim 1, which comprises screening step d), wherein the screening d) results in granules having a particle diameter in the range from 40 to 70 μm.

5. Process according to claim 1, wherein the precursor compounds are selected from the group consisting of hydroxides, carbonates, nitrates, oxalates and other salts of lower carboxylic acids of the metals cobalt, manganese, iron, molybdenum and nickel.

6. Process according to claim 5, wherein the precursor compounds are selected from the group consisting of hydroxides, carbonates and nitrates at least of cobalt, manganese, iron, molybdenum or nickel.

7. Process according to claim 1, wherein the solution formed in step a) comprises dissolved and/or suspended in the solvent, together with the precursor compounds for the catalyst, precursor compounds for a catalyst support selected from the group consisting of: the metal compounds of aluminium, magnesium, calcium, titanium, cerium and lanthanum.

8. Process according to claim 7, wherein the metal compounds are selected from the group consisting of: hydroxides, carbonates and nitrates of aluminium, magnesium, calcium and titanium.

9. Process according to claim 1, which further comprises, in step a), recycling fine dust of catalyst material from the screening in step d) to the solution.

10. Process according to claim 1, which further comprises carrying out the drying e) and the calcination f) in a common reaction chamber.

11. Process according to claim 1, which further comprises carrying out the spray granulation or spray drying in step b) using a single-component atomizing nozzle or a two-component atomizing nozzle, with admixture of inert gas or air in the atomization.

12. Process according to claim 11, which further comprises carrying out the spray granulation or spray drying using a single-component atomizing nozzle with a pressure difference over the nozzle of from 5*10⁵ to 300*10⁵ Pa (from 5 to 300 bar).

13. Process according to claim 11, which further comprises carrying out the spray granulation or spray drying using a two-component atomizing nozzle with admixture of inert gas or air, wherein the ratio of the gas mass flow to the liquid mass flow is from 0.1 to 1 to 2 to 1.

14. Process according to claim 1, which further comprises using a disc atomizer to remove the solvent in step b), wherein the disc atomizer is operated with a speed of the atomizer disc in the range from 2000 to 20,000 rpm.

15. Process according to claim 1, which further comprises feeding waste gases and/or hot gases obtained in the drying e) and/or calcination f) back to the process for heat exchange when the spray drying is carried out.

16. A catalyst for producing carbon nanotubes, obtained from a process according to claim 1.

17. A process for producing fibrous carbon materials comprising decomposition of hydrocarbons with and without heteroatoms on a catalyst, optionally in the presence of inert gas and/or hydrogen at a temperature of from 450 to 1200° C. in a fixed bed or a moving bed, wherein the catalyst is a catalyst according to claim 16.

18. Process according to claim 17, wherein the fibrous carbon materials are carbon nanotubes.

19. Carbon nanotubes produced according to the process according to claim 17.

20. A product comprising carbon nanotubes according to claim 19, wherein said product is selected from the group consisting of: polymer composite materials, ceramics or metal composite materials, conductive coatings, batteries, capacitors, displays or illuminants, field effect transistors, storage media, membranes, catalysts, catalyst support materials, medical devices and materials, and diagnostic devices and materials.
